(19) United States
(12) Patent Application Publication
(10) Pub. No.: US 2025/0122636 A1
(43) Pub. Date: Apr. 17, 2025

(54) ELECTROCHEMICAL APPARATUS FOR EXTRACTING COPPER FROM COPPER-CONTAINING WASTEWATER AND EXTRACTION METHOD

(71) Applicant: DONGGUAN UNIVERSITY OF TECHNOLOGY, DONGGUAN (CN)

(72) Inventors: GANG WANG, DONGGUAN (CN); SHIYONG WANG, DONGGUAN (CN); CHANGPING LI, DONGGUAN (CN); SIHAO LV, DONGGUAN (CN); LIN ZHAO, DONGGUAN (CN); CHEN YANG, DONGGUAN (CN)

(21) Appl. No.: 18/986,713

(22) Filed: Dec. 19, 2024

Related U.S. Application Data
(63) Continuation of application No. PCT/CN2023/113438, filed on Aug. 17, 2023.

(30) Foreign Application Priority Data
May 5, 2023 (CN) 202310492835.2

(51) Int. Cl. C25C 1/12; B01D 61/46; C25C 7/02; C25C 7/04; C25C 7/08

(52) U.S. Cl. CPC C25C 1/12; B01D 61/461; C25C 7/02; C25C 7/04; C25C 7/08; B01D 2313/345

(57) ABSTRACT

The present disclosure relates to an electrochemical device for extracting copper from copper-containing wastewater and an extraction method using the same. Cu-based chalcogenide, as an electrode material, forms an electrochemical device with other electrodes. The device is an electrocatalytic coupling deionization system with electrochemical oxidative decomplexing performance, and has a good selective removal effect of Cu²⁺ from organic complex copper-containing wastewater, strongly acidic wastewater, and wastewater interfered by high concentration salt ions and heavy metal ions. With this device, the organic complex pollutant Cu-EDTAn can be effectively decomplexed to complete the extraction of Cu²⁺.

### TECHNICAL FIELD

The disclosure relates to the technical field of heavy metal wastewater treatment, in particular to an electrochemical device for extracting copper from copper-containing wastewater and an extraction method using the same.

### BACKGROUND

Copper resources play an important role in modern industrial technology, covering important fields such as communication, infrastructure, electricity, electronic equipment and transportation. Therefore, the application of copper will become more and more prominent in the future. The demand for copper increased rapidly throughout the 20th century, accompanied by the increasing scarcity of copper resources. Moreover, copper is a common heavy metal pollutant in wastewater produced by industrial processes such as copper mining and smelting, circuit printing and metal electroplating, with a high concentration. In typical electroplating wastewater, the concentration of copper can reach 1,500 mg/L. Etching copper with ammonia solution is a common method in printed circuit board manufacturing; it is reported that the concentration of copper in its waste liquid is as high as 150 g/L. The copper discharge standard is very strict, ranging from 3.0 mg/L in India to 0.1 mg/L in Italy. If untreated and substandard copper-containing wastewater is discharged into the environment, Cu²⁺ will combine with precipitates, be absorbed by animals and plants, finally enter the human body through the food chain, accumulate in the human body, and pose a potential threat to human health.

The discharge of heavy metal wastewater not only seriously threatens environmental safety and human health, but also causes a huge waste of heavy metal resources, which goes against the concept of green development. It is an important way to solve the current heavy metal pollution and copper resource shortage by effectively removing copper pollution in wastewater while extracting copper, so as to realize the recovery of copper resources. However, on the one hand, copper-containing wastewater from smelting and electroplating industries is generally characterized by strong acidity (sulfuric acid content up to 5%-10%) under severe environmental conditions. The strong corrosivity and high toxicity of acid waste liquid make it a harmful waste, which makes the efficient recovery of copper face challenges. In addition, some organic complexing agent pollutants discharged from industries, such as ethylenediaminetetraacetic acid, will form stable complexes with heavy metals, which have the characteristics of difficulty in biodegradation, bioaccumulation, high toxicity and high stability, and are difficult to be treated by general water treatment methods.

In order to meet the discharge standards, researchers around the world have developed various treatment processes to remove Cu²⁺ from industrial wastewater, including chemical precipitation, adsorption, membrane separation, electrodialysis and other treatment technologies.

The conventional treatment of copper and most heavy metals is by precipitation, which forms insoluble hydroxides or sulfides under alkaline pH conditions. However, this method is complicated and requires two steps of pH adjustment to destroy the copper complex, and relies on ferrous ions to reduce bivalent copper to cuprous to prevent it from being re-complexed.

The action mechanism of adsorption is to use the accumulation at the solid-liquid interface between water pollutants and adsorbents to adsorb on the adsorbent surface through physical or chemical actions, so as to achieve the purpose of removing water pollutants. Adsorption is one of the most commonly used processes for treating copper-containing wastewater due to its simple design and low operating cost. However, the operating range of Cu²⁺ concentration is often limited, which hinders rapid metal uptake and frequent regeneration.

Membrane technologies have evolved from microfiltration (MF) and ultrafiltration (UF) to nanofiltration (NF) and reverse osmosis (RO). For copper ions, improving membrane selectivity requires a better understanding of the basic knowledge of solute transport in a porous membrane medium. In addition, in terms of membrane separation, this method faces problems such as high membrane cost, membrane pollution and complex actual water environment in industrial applications.

A typical electrodialysis process is used to treat wastewater from the metal deposition and electroplating industries. This is a strategy suitable for non-selective copper removal and recycling. However, the residual wastewater produced in copper ore processing has strong acidity and contains high concentrations of heavy metals such as iron, zinc and copper, which is difficult to be effectively treated.

Therefore, it is urgent to develop an economical and efficient method for treating copper-containing wastewater so as to realize the recovery of copper from wastewater.

### SUMMARY

In order to solve the above problems, the present disclosure provides an electrochemical device for extracting copper from copper-containing wastewater and an extraction method using the same, which realizes high selective adsorption and efficient extraction and recovery of copper ions from copper-containing wastewater.

A first aspect of the present disclosure provides an electrochemical device for extracting copper from copper-containing wastewater, wherein an anode material of the electrochemical device is one of activated carbon, graphite, lead dioxide, BDD and CuₘX_{1-a-b}YₐZ_{b}; a cathode material is one of CuₙX_{1-c-d}Y_{c}Z_{d} and carbon-selenium composite materials, and a cathode and an anode are respectively connected with a power supply to treat the copper-containing wastewater;

wherein 1<m≤2, 1≤n<2 and m>n; 0≤a≤1, 0≤b≥1 and 0≤a+b≤1; 0≤c≤1, 0≤d≤1 and 0≤c+d≤1; X, Y and Z are selected from a group consisting of S, Se and Te. specifically, the CumX1-a-bYaZb and CunX1-c-dYcZd are Cu-based chalcogenides, which can be cited as follows: CuS, CuSe, CuTe, CuS@CuSe, CuS0.3Se0.7. CuS0.5Se0.5, CuS0.7Se0.3, CuS0.3Se0.7, Cu2S, Cu2Se, Cu2Te, Cu2S0.3Se0.7, Cu2S0.7Se0.3, Cu2Se0.7Te0.3 etc.

In some of the embodiments, wherein the anode material of the electrochemical device is one of activated carbon, graphite, lead dioxide and BDD materials; the cathode material is one of copper selenide, copper selenide sulfide and carbon-selenium composite materials; the anode and the cathode are connected to the power supply and applied with a direct current of 0.6-4.0V, and the device is used for treating acidic electroplating wastewater containing Cu-EDTA.

In some of the preferred embodiments, in terms of the electrochemical device, an activated carbon electrode is used as an anode and a copper selenide electrode prepared by a hydrothermal method as a cathode. The anode and the cathode are connected through wires and powered on to apply a DC voltage of 0.6V-4.0V to obtain the electrochemical device, which is used to treat organic wastewater containing Cu-EDTA and acidic electroplating wastewater. The device system is used for the electrochemical oxidative decomplexing of Cu-EDTA and selective adsorption of Cu(II) ions released after decomplexing at a copper selenide cathode.

In the present disclosure, Cu(II) ions represent divalent copper ions and Cu(I) ions represent monovalent copper ions.

In some of the embodiments, wherein the preparation steps of the copper selenide material are as follows:

stirring and dissolving selenium powder in hydrazine hydrate to obtain a mixture A; mixing ethanol with water, adding anhydrous copper chloride for stirring and dissolving to obtain a mixture B; mixing A and B to obtain a mixture C, putting the mixture C into an oven, heating it to 150-200° C. to react for 20 h-30 h to obtain a crude product of copper selenide.

In some of the embodiments, wherein the molar ratio of the selenium powder to the anhydrous copper chloride is 1:1.

In some of the embodiments, wherein when the cathode material is copper selenide, the cathode electrode is obtained by the following method:

mixing conductive carbon black and copper selenide material evenly, adding them into a solvent for stirring, adding a binder and continuing to stir until an uniform mixture is obtained; coating the obtained mixture on a graphite paper, drying the coated graphite paper at 60° C. for 24 h, and finally obtaining a cathode electrode with copper selenide as an active material. Specifically, the solvent is anhydrous ethanol; and the drying temperature is 60° C.

With the above copper selenide powder being replaced with activated carbon powder, the anode electrode used as a system can be prepared by using the same method; specifically, the anode electrode is obtained by using the following method:
mixing conductive carbon black and activated carbon material evenly, adding them into a solvent for stirring, adding a binder and continuing to stir until an uniform mixture is obtained; coating the obtained mixture on graphite paper, drying the coated graphite paper at 60° C. for 24 h, and finally obtaining an anode electrode for electrocatalysis with activated carbon as an active material.

Assemble the above electrodes into a device system to treat acidic wastewater containing Cu-EDTA pollutants. Specifically, the above copper selenide cathode, activated carbon anode, power supply and 50 mL of copper-containing wastewater are jointly constructed into an electrochemical device. Under a certain voltage, charged ions in the waste liquid are attracted to electrodes with opposite charges respectively, and concentrated sulfuric acid is used to adjust pH value and acid conditions, so that anodic oxidative decomplexing and a cathodic selective adsorption reaction of Cu²⁺ occur. In addition, the concentrations of Cu²⁺ and Cu-EDTA in the waste liquid are measured, and the composition analysis of Cu-EDTA is carried out to judge the copper extraction effect. The electrochemical oxidative decomplexing system with a copper selenide electrode as the cathode can selectively extract Cu²⁺ released by anodic decomplexing under the conditions of strong acidity and complex ion composition, so as to achieve the purpose of recovering copper resources. Specifically, the power supply voltage is 0.6V-4.0V and the pH value is 0.1-5.

In some of the preferred embodiments, the electrochemical device further comprises an anion exchange membrane.

According to a second aspect of the present disclosure, there is provided a method for extracting copper from copper-containing wastewater by an electrochemical process using the electrochemical device according to any one of the above.

In some of the embodiments, the method comprises the following steps of:
(1) synchronous realization of copper embedding and decoppering processes: use an electrodialysis reactor, with a CuₘX_{1-a-b}YₐZ_{b} electrode as an anode and a CuₙX_{1-c-d}Y_{c}Z_{d} electrode as a cathode; separate the anode and the cathode with an anion exchange membrane; add a supporting electrolyte salt solution into an anode chamber, and add copper-containing wastewater to be treated into a cathode chamber; after being energized, a copper-rich electrode is formed at the cathode and a copper-deficient electrode is formed at the anode; a high-concentration copper-containing solution is obtained in the anode chamber, and Cu(II) ions in the copper-containing wastewater in the cathode chamber is selectively adsorbed to the cathode material; and
(2) regeneration process: after the reaction in step (1) is completed, switch the positive and negative poles of the power supply to exchange electrodes; replace the solution in the anode chamber after electrode exchange with a fresh supporting electrolyte salt solution, and replace the solution in the cathode chamber after electrode exchange with copper-containing wastewater; electrify the anode again for decoppering and the cathode for copper embedding, so as to extract copper from the copper-containing wastewater and complete the cyclic regeneration of electrodes;
wherein 1<m≤2, 1≤n<2 and m>n; 0≤a≤1, 0≤b≤1 and 0≤a+b≤1; 0≤c≤1, 0≤d≤1 and 0≤c+d≤1; X, Y and Z are selected from a group consisting of S, Se and Te.

In some of the preferred embodiments, the method comprises the following steps of: (1) synchronous realization of copper embedding and decoppering processes: use an electrodialysis reactor, with a Cu2Se electrode as an anode and a CuSe electrode as a cathode; separate the anode and the cathode with an anion exchange membrane; add a supporting electrolyte salt solution into an anode chamber, and add copper-containing wastewater to be treated into a cathode chamber; after being energized, Cu(II) ions in the copper-containing wastewater of the cathode chamber embed into the cathode material to form a copper-rich Cu2Se electrode, and at the same time, Cu2Se as an anode active material loses copper (I) ions to become a copper-deficient CuSe electrode; a high-concentration copper-containing solution is obtained in the anode chamber, and Cu(II) ions in the copper-containing wastewater flowing into the cathode chamber will be selectively adsorbed to the cathode material;
(2) regeneration process: after the reaction in step (1) is completed, switch the positive and negative poles of the power supply to exchange electrodes; with a copper-rich Cu₂Se electrode generated in step (1) as the anode and a copper-deficient CuSe electrode generated in step (1) as the cathode, replace the solution in the anode chamber where the copper-rich Cu₂Se electrode is located with a fresh supporting electrolyte salt solution, and replace the solution in the cathode chamber where the copper-deficient CuSe electrode is located with copper-containing wastewater; electrify the anode again for decoppering and the cathode for copper embedding, so as to extract copper from the copper-containing wastewater and complete the cyclic regeneration of electrodes.

step (1) constructing a system of “Cu₂Se electrode|supporting electrolyte|anion exchange membrane|copper-containing wastewater|CuSe electrode” for simultaneous copper extraction and decoppering; step (2): constructing a system of “CuSe electrode|copper-containing wastewater|anion exchange membrane|supporting electrolyte|Cu₂Se electrode” by switching positive and negative poles of a battery and adjusting solutions in the anode and the cathode chambers for electrode regeneration and obtaining a copper-rich solution, so as to realize a high selective extraction and recovery of copper from copper-containing wastewater, and carry out wastewater treatment as well as electrode regeneration, thus further improving the treatment efficiency and reducing the cost of electrode materials.

In some of the embodiments, wherein after the step (1) or the step (2) is completed, collect the high-concentration copper-containing solution in the anode chamber and use it after impurity removal for electrolytic refining of blister copper.

In some of the embodiments, wherein the concentration of Cu(II) ions in the high-concentration copper-containing solution is above 10,000 mg/L, and the method for impurity removal is electrolysis. It should be noted that when Cu-based chalcogenide is simultaneously used as cathode and anode active materials to form counter electrodes, which are assembled with an anion exchange membrane and a power source to form an electrodialysis reaction device for treating copper-containing wastewater, the concentration of Cu(II) ions in the finally obtained high-concentration copper-containing solution is usually compatible with the concentration of Cu(II) ions in the copper-containing wastewater; in order to carry out the enrichment of Cu(II) ions when treating wastewater containing less copper, in addition to using a fresh supporting electrolyte solution for the first time, in subsequent treatments, an anode chamber solution collected from the previous treatment (of i.e., high-concentration copper-containing wastewater) instead of the supporting electrolyte solution until the concentration of Cu(II) ions in the high-concentration copper-containing solution reaches a higher enrichment concentration, such as 10,000 mg/L required for electrolytic extraction of copper, to complete enrichment of Cu(II) ions, and the concentration of Cu(II) ions in the high-concentration copper-containing solution at the very moment is a cumulative concentration of the treatment process.

In addition, for the purpose of the electrochemical device according to the present disclosure, a plurality of groups of cathodes and anodes are usually connected in series correspondingly and assembled with a plurality of anion exchange membranes and a power source to form an integrated device in practical applications. The integrated device includes a plurality of treatment modules, thereby improving the copper-containing wastewater treatment capacity per unit volume of the device; when the concentration of Cu(II) ions in copper-containing wastewater does not meet the discharge requirements of copper-containing wastewater or the concentration of enriched copper ions does not reach a required concentration, if the Cu(II) ions adsorbed in the cathode have not yet reached saturation at the very moment, after a primary treatment, it is only necessary to replace the wastewater treated by the cathode chamber with fresh copper-containing wastewater without replacing the anode chamber solution, and continue to electrify for treatment. Repeat this operation until the cathode's adsorption is saturated, so that the enrichment of Cu(II) ions can be realized in the anode chamber; if the cathode's adsorption has been saturated, reverse electrodes for regeneration and further treatment. In some of the embodiments, in step (1) and step (2), the energizing voltage is 0.1V-1.4V, and the energizing time is 60 min-180 min. In some of the embodiments, wherein in the step (1), the Cu₂Se electrode is prepared by mixing Cu₂Se, conductive carbon material and binder PVDF at a mass ratio of 7-9:2-0.5:1-0.5.

In some of the embodiments, wherein in the step (1), the CuSe electrode is prepared by mixing CuSe, conductive carbon material and binder PVDF at a mass ratio of 7-9:2-0.5:1-0.5.

In some of the embodiments, wherein the conductive carbon material is one or more selected from a group consisting of acetylene black, carbon nanotubes, graphene, graphite and carbon fiber.

Specifically, the preparation method of CuₘX_{1-a-b}YₐZ_{b} anode and CuₙX_{1-c-d}Y_{c}Z_{d} cathode is similar to that of Cu₂Se and CuSe. Mix CuₘX_{1-a-b}YₐZ_{b}, conductive carbon material and binder PVDF at a mass ratio of 7-9:2-0.5:1-0.5 to prepare the anode; and mix CuₙX_{1-c-d}Y_{c}Z_{d}, conductive carbon material and binder PVDF at a mass ratio of 7-9:2-0.5:1-0.5 to prepare the cathode.

In some of the embodiments, wherein in step (1) and step (2), the supporting electrolyte salt solution is a sulfate solution or a chloride solution, a concentration of sulfate ions in the sulfate solution is 0.1 mol/L-2 mol/L, and a concentration of chloride ions in the chloride solution is 0.1 mol/L-2 mol/L.

Illustratively, the sulfate solution can be cited as follows: sodium sulfate solution, potassium sulfate solution, magnesium sulfate solution, ammonium sulfate solution, zinc sulfate solution, etc.; the chloride solution can be cited as follows: sodium chloride solution, potassium chloride solution, ammonium chloride solution, etc.

In some of the embodiments, wherein the step (2) is repeated 10 times to 20 times.

In some of the embodiments, wherein the copper-containing wastewater is one of acidic electroplating wastewater, integrated discharged wastewater generated in circuit board printing, copper-containing wastewater from copper ore smelting and copper-containing wastewater after decomplexing.

In some of the embodiments, wherein the concentration of Cu(II) ions in the copper-containing wastewater is 0.5 mg/L-10,000 mg/L; and the pH value of the copper-containing wastewater is 0.1-5.0. Specifically, when the pH of the copper-containing wastewater is greater than 5.0, it is necessary to adjust the pH to 0.1-5.0 with sulfuric acid or hydrochloric acid.

Compared with the prior art, the present disclosure has the following beneficial effects:
(1) In the present disclosure, Cu-based chalcogenide, as an electrode material, forms an electrochemical device with other electrodes such as carbon materials and BDD. The device is an electrocatalytic coupling deionization system with electrochemical oxidative decomplexing performance, and has a good effect of selectively removing Cu(II) ions from organic complex copper-containing wastewater, strongly acidic wastewater, and wastewater interfered by high-concentration salt ions and heavy metal ions; with this device, the organic complex pollutant Cu-EDTA can be effectively decomplexed to make it degrade into a lower order complex form or even completely degrade and release Cu(II) ions, thus completing the extraction of Cu(II) ions; more importantly, compared with CuS electrode, CuSe still has a higher electroadsorption capacity in acidic environment (1 mol/L hydrochloric acid).
(2) In the present disclosure, Cu-based chalcogenide is further simultaneously used as cathode and anode active materials to form counter electrodes. The counter electrodes are assembled with an anion exchange membrane and a power source to form an electrodialysis reaction device, so that decoppering and copper embedding reactions can be carried out at the same time within a lower voltage and a wider pH range. The regeneration step combined with electrodes enables a continuous copper extraction operation, greatly improves copper extraction efficiency, and has high removal efficiency and good selectivity of Cu(II) ions from copper-containing wastewater;
(3) The Cu-based chalcogenide electrode material of the present disclosure has the advantages of high adsorption capacity and strong selectivity in treating copper-containing electroplating wastewater, and can realize selective extraction of Cu(II) ions under the conditions of interference by high-concentration salt ions and other heavy metal ions and high acidity; in the present disclosure, double Cu-based chalcogenide electrodes are used as two electrodes of an electrochemical reactor and have excellent performance in extraction of Cu(II) ions, achieving a higher adsorption capacity of copper ions under a low voltage condition; the electrode pair further exhibit a good selective adsorption capacity (with the removal efficiency >90%) of Cu(II) ions in high-concentration polymetallic ion coexistence system; moreover, the double Cu-based chalcogenide electrode pair treatment system of the present disclosure is also suitable for treating copper-containing wastewater within a wide pH range, and overcomes the limitation that conventional adsorbent materials can only carry out copper extraction operation in a narrow pH range; the present disclosure verifies the feasibility of the double Cu-based chalcogenide electrode pair system for effectively extracting copper ions in treating actual wastewater, and can be applied to selective extraction of Cu(II) ions from strongly acidic copper-containing wastewater with complex components, opening up a new way for fields such as extraction and recovery of copper resources from wastewater;
(4) The excellent removal performance of the double Cu-based chalcogenide electrode pair for Cu(II) ions originates from the reversible conversion between different Cu-based chalcogenide electrodes in the double Cu-based compound electrode pair; by switching positive and negative poles of a power source and adjusting the solution of the cathode and anode chambers, the reversible conversion of the electrodes, i.e., electrode regeneration, is carried out simultaneously with the copper extraction process, thus realizing continuous treatment of copper-containing wastewater, greatly improving the copper extraction efficiency and prolonging the service life of the electrodes, thereby reducing the treatment cost.

### BRIEF DESCRIPTION OF DRAWINGS

A brief introduction is made below to the figures necessary for the description of the embodiment or the prior art to illustrate the technical solution in the embodiments of the present disclosure or in the prior art more clearly. Apparently, the figures in the following description are only some embodiments of the present disclosure, and those of ordinary skill in the art can derive other drawings from these figures without creative work.

FIG. 1 is an X-ray diffraction spectrum of the obtained copper selenide electrode material;

FIG. 2 is a scanning electron micrograph of the obtained copper selenide electrode material;

FIG. 3 is a schematic device diagram of the combined device;

FIG. 4 is a curve showing changes in concentration of Cu-EDTA over time when wastewater containing Cu-EDTA is treated in Embodiment 1;

FIG. 5 is a graph showing changes in adsorption of copper and other ions by the cathode electrode of copper selenide when acidic electroplating wastewater is treated in Embodiment 2;

FIG. 6 is a graph showing the adsorption of copper and other heavy metals by a cathode electrode of copper selenide when wastewater containing a complex system of multi-component heavy metals is treated in Embodiment 3;

FIG. 7 is a schematic structural diagram of the electrochemical device constructed in Embodiment 4;

FIG. 8 is a schematic structural diagram of the electrochemical device in the regeneration process in Embodiment 4;

FIG. 9 is a graph showing the adsorption of copper and other ions when treating copper pit water from a copper mine in Embodiment 4.

in which, 1—Cu₂Se anode; 2—CuSe cathode; 3—anion exchange membrane; 4—DC power supply; 5—supporting electrolyte; 6—copper-containing wastewater; 11—Cu₂Se anode obtained by inlaying copper into CuSe; 21—CuSe cathode obtained by decoppering from Cu₂Se; 3—anion exchange membrane; 4—DC power supply; 5—supporting electrolyte; 6—copper-containing wastewater

### DETAILED DESCRIPTION OF THE EMBODIMENTS

The technical solutions of the present disclosure will be clearly and completely described below in combination with specific embodiments. Obviously, the described embodiments are only some rather than all of the embodiments of the present disclosure. Based on the embodiments of the present disclosure, all other embodiments obtained by ordinary persons skilled in the art without creative efforts shall fall within the protection scope of the present disclosure.

### Copper Selenide Electrode Material:

Dissolve 0.316 g of selenium powder in 10 mL of hydrazine hydrate and stir them vigorously at 70° C. to form a mixture A. Dissolve 0.523 g of anhydrous copper chloride in an ethanol-water mixture with a volume ratio of ethanol to water being 3:2, mix and stir them to form a mixture B. Add mixture A dropwise to mixture B and stir them at room temperature for 30 min. Subsequently, transfer the reactants to a reactor, put the reactor into an oven, and adjust the temperature to 180° C. for 24 h of reaction. After cooling to room temperature, wash the solid product several times with absolute ethanol and deionized water. At the end, put the washed the solid product into an oven and dry it at 60° C. for 24 h to obtain a copper selenide electrode material.

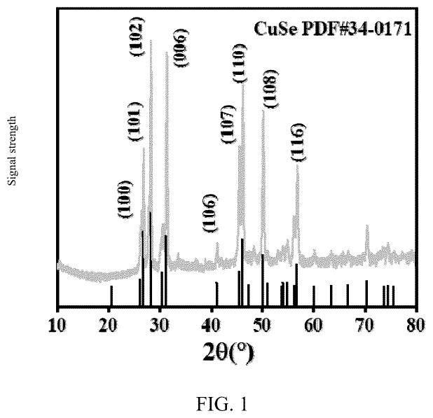

An X-ray diffraction spectrum of the obtained copper selenide electrode material is as shown in FIG. 1, where the main diffraction peaks of the sample exactly match the characteristic peaks corresponding to hexagonal copper selenide (CuSePDF #34-0171). At the same time, no other impurity peaks appear, which indicates that the copper selenide material is successfully prepared and the obtained sample has a high purity.

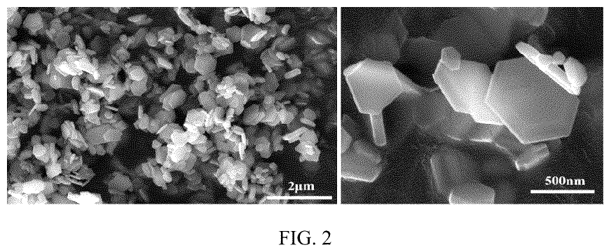

FIG. 2 is a scanning electron micrograph of the prepared copper selenide material. It can be seen that the copper selenide nanomaterials exhibit an irregular hexagonal nanoplatelet shape with a size of about 200 nm to 500 nm, and are relatively dispersed without stacking.

### Preparation of Copper Selenide Cathode Electrode:

Mix uniformly the copper selenide electrode material prepared above, as an active material, with conductive carbon black at a mass ratio of 8:1. Add absolute ethanol and stir them evenly, and then add a binder. The ratio of active material to binder is 8:1, and stir them evenly. Subsequently, coat the obtained mixture onto a graphite paper, with a coating thickness of 100-600 μm. Dry the coated graphite paper at 60° C. for 24 h to obtain copper selenide, the active material, which will be used as a cathode electrode material.

An activated carbon anode electrode is prepared in the same way: Mix uniformly the activated carbon, as an active material, with conductive carbon black at a mass ratio of 8:1. Add absolute ethanol and stir them evenly, and then add a binder. The ratio of active material to binder is 8:1, and stir them evenly. Subsequently, coat the obtained mixture onto a graphite paper, with a coating thickness of 100-600 μm. Dry the coated graphite paper at 60° C. for 24 h to obtain an anode electrode for electrocatalysis using activated carbon as an active material.

A combination device of electrochemical oxidative decomplexing and cathodic selective copper extraction is constructed by the prepared copper selenide cathode electrode and activated carbon anode electrode.

### Embodiment 1

The device manufactured as described above is used for treating wastewater containing Cu-EDTA pollutants and acidic electroplating wastewater, i.e., extraction of copper. The specific method is as follows:

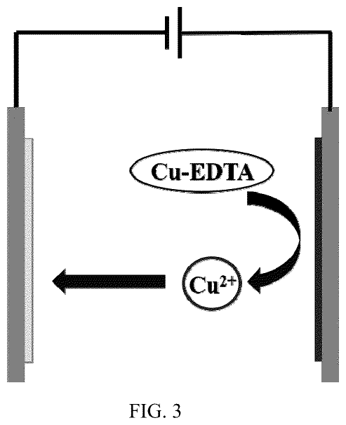

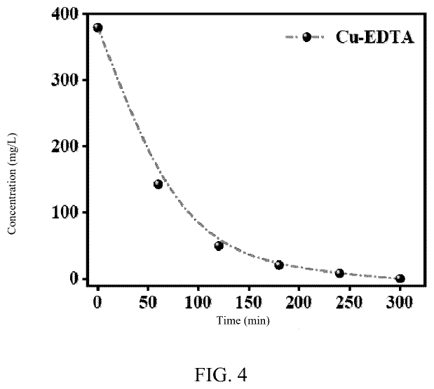

Combine copper selenide cathode electrode, activated carbon anode electrode, power source and 50 mL copper-containing waste liquid to form a unified system. At a voltage of 1V, the charged ions in the waste liquid are attracted to the electrodes with opposite charges respectively, and the pH value is adjusted to 1 by concentrated sulfuric acid, resulting in anodic oxidative decomplexing reaction and cathodic selective adsorption of Cu²⁺. The schematic diagram of the device is as shown in FIG. 3. In addition, determine concentrations of Cu²⁺ and Cu-EDTA in the waste liquid, and analyze composition of Cu-EDTA. As shown in FIG. 4, after a high performance liquid chromatography test and a 300 min electrochemical treatment process, the concentration of Cu-EDTA in the waste liquid is significantly reduced from 400 mg/L to 0.2 mg/L, indicating that the capacitive deionization system has a good effect of removing Cu-EDTA from the waste liquid. Under normal conditions, Cu-EDTA exists in the form of negative charge in wastewater. Under the action of voltage, Cu-EDTA is attracted to the anode of activated carbon. Due to the anodic oxidation of activated carbon anode, substances such as hydroxide free radicals generated destroy the complex structure of Cu²⁺ and -EDTA-, generate lower-order copper complex species or directly release Cu²⁺, thus realizing the decomplexing of Cu-EDTA. The released Cu²⁺ is attracted by the cathode under the action of voltage and finally recovered by the copper selenide electrode.

### Embodiment 2

The above device is used for selective extraction of copper from actual acidic electroplating wastewater. The specific method is as follows:

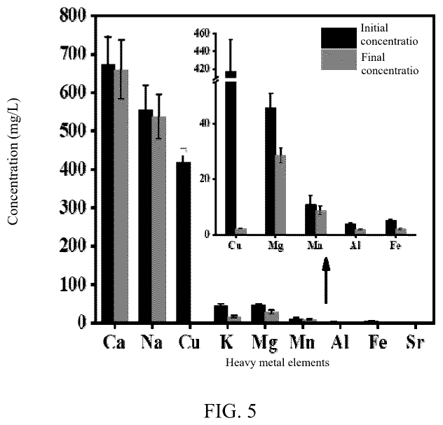

Adjust electroplating wastewater sampled from a plating material company to a strongly acidic pH value of 1, and treat the wastewater by a combined device for electrochemical oxidative decomplexing and cathodic selective copper extraction in the same manner as in Embodiment 1. As shown in FIG. 5, after adsorption, the Cu²⁺ concentration decreases from 417.12 mg/L to 1.92 mg/L. Under other ion interference conditions (Na⁺: 553.97 mg/L, Ca²⁺: 672.91 mg/L), the removal rate of Cu²⁺ reaches 99.52%. In contrast, the removal rates of Na⁺ and Ca²⁺ are only 3.21% and 1.95%, respectively. The results show that even under the actual conditions of strong acidity and high concentration of interfering ions, the copper selenide electrode can still exhibit excellent adsorption performance and selectivity for Cu²⁺.

### Embodiment 3

The above-mentioned device is used for the selective extraction of copper under heavy metal interference. The specific method is as follows:

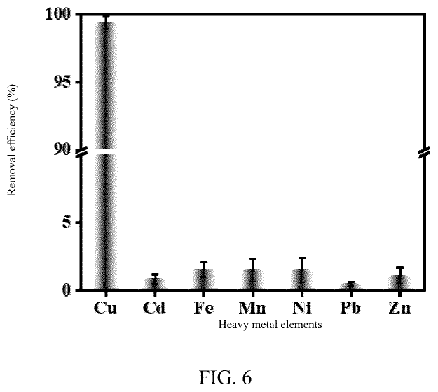

The copper selenide electrode is used to electrosorb the mixed solution system with a concentration of copper (10 mg/L) to that of other heavy metals at 1:10, respectively. The specific experiment is the same as that in Embodiment 1. As shown in FIG. 6, the results show that even under the concentration ratio of 1:10, the removal rate of copper selenide electrode for Cu²⁺ is as high as 99.02%, while the removal rates of other ions are low. The calculation equation of a removal rate is as follows:

$$R E = \frac{{C}_{0} - {C}_{t}}{{C}_{0}} \times 100 \%$$

RE: removal efficiency; Co: initial concentration; Ct: equilibrium concentration.

Use a hydrothermal method to prepare copper selenide with a high purity. Use the prepared copper selenide material to prepare copper selenide electrode as a cathode, and use activated carbon to prepare activated carbon electrode as an anode. Use the prepared cathode and anode to construct an electrochemical assembly “activated carbon electrode|copper-containing wastewater|CuSe electrode” for treating copper-containing wastewater, wherein Embodiment 1 is used to treat wastewater containing Cu-EDTA. The results show that the electrochemical device system according to the present disclosure has electrochemical oxidative decomplexing performance, the organic complex pollutant Cu-EDTA can be effectively decomplexed to make it degrade into a lower order complex form or even completely degrade and release Cu²⁺. Moreover, the electrochemical system according to the present disclosure can adsorb the released Cu²⁺, thereby realizing extraction and recovery of Cu²⁺. Embodiment 2 is used to treat acidic electroplating wastewater. The results show that the electrochemical device system according to the present disclosure has excellent adsorption performance and selectivity of Cu²⁺ under the condition of strong acidity and high concentration of interfering ions. Embodiment 3 is used to treat copper-containing wastewater containing various heavy metals. The results show that the electrochemical device system according to the present disclosure has a good removal rate and selectivity of Cu²⁺ under the interference of heavy metals.

### Embodiment 4

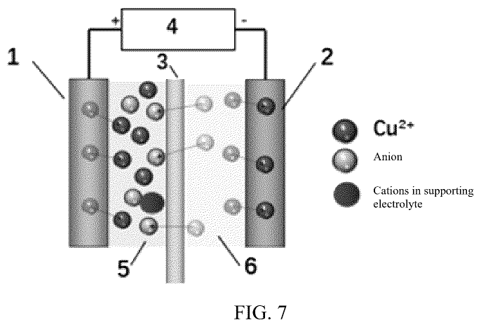

(1) Synchronous realization of copper embedding and decoppering processes: Set up an electrochemical device. The schematic structure diagram of the device is as shown in FIG. 7. Use an electrodialysis reactor, with a Cu₂Se electrode as an anode and a CuSe electrode as a cathode: separate the anode and the cathode with an anion exchange membrane; add 100 mL sodium sulfate solution (the concentration of sulfate ion is 0.5 mol/L), a supporting electrolyte solution, into an anode chamber, and add 100 mL copper-containing wastewater (the concentration of Cu(II) ion is 200 mg/L) to be treated into a cathode chamber; after being energized and 1 V DC voltage being applied, Cu(II) ions in the copper-containing wastewater from the cathode chamber are embedded into the cathode material to form a copper-rich Cu₂Se electrode. The reaction is as follows: CuSe+2e⁻+Cu²⁺=Cu₂Se, and at the same time, Cu₂Se as an anode loses Cu(I) ions to become a copper-deficient CuSe electrode. The reaction is as follows: Cu₂Se−2e⁻=CuSe+Cu²⁺; after 60 min of energization, the anode chamber obtains a high-concentration copper-containing solution of 199.36 mg/L. Cu(II) ions in the copper-containing wastewater flowing into the cathode chamber will be selectively adsorbed to the cathode material, and the concentration of copper ions in the treated copper-containing wastewater is 0.89 mg/L.

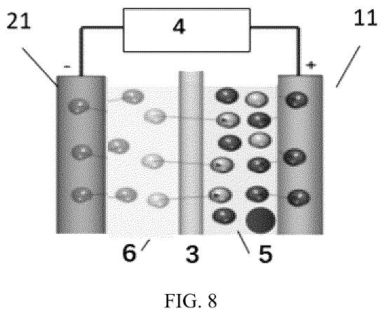

(2) Regeneration process: After the reaction is completed, switch the positive and negative poles of the power supply to exchange electrodes. With a copper-rich Cu₂Se electrode generated in step (1) as the anode and a copper-deficient CuSe electrode generated in step (1) as the cathode, replace the solution in the anode chamber where the copper-rich Cu₂Se electrode is located with 100 mL of sodium sulfate solution (the concentration of sulfate ion is 0.5 mol/L), a fresh supporting electrolyte salt solution and replace the solution in the cathode chamber where the copper-deficient CuSe electrode is located with 100 mL of copper-containing wastewater (the concentration of Cu(II) ions is 200 mg/L); FIG. 8 shows the schematic structural diagram of the electrochemical device in the regeneration process, where the process of step (1) is repeated by energizing again with an electrification voltage of 1 V and an electrification time of 60 min to perform anode decoppering and cathode copper embedding, so that 198.44 mg/L high-concentration copper-containing solution can be obtained in the anode chamber, and Cu(II) ions in the copper-containing wastewater flowing into the cathode chamber will be selectively adsorbed to the cathode material so as to extract copper from the copper-containing wastewater and complete the cyclic regeneration of electrodes at the same time.

In step (1), the Cu₂Se electrode is prepared by mixing Cu₂Se, acetylene black and binder PVDF at a mass ratio of 7:0.5:1, and the CuSe electrode is prepared by mixing CuSe, acetylene black and binder PVDF at a mass ratio of 7:0.5:1. The specific preparation method is the same as that in Embodiment 2.

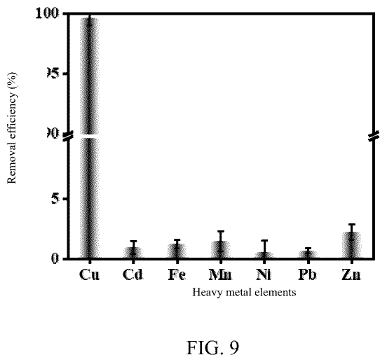

The copper-containing wastewater is the copper pit water of a copper mine with pH=2, and its chemical composition is as shown in Table 1. FIG. 9 shows the adsorption of copper and other ions in the copper pit water by the electrochemical device and method according to the present disclosure.

TABLE 1
Chemical Composition of
Copper Pit Water (in mg/L)

| Composition | Cu | Fe | Ca | Zn | Pb | SO₄²⁻ |
|---|---|---|---|---|---|---|
| Content | 200 | 2000 | 180 | 96 | 1.8 | 15000 |

As can be seen from FIG. 9, in Embodiment 4, an electrochemical device is constructed with “CuSe|Cu₂Se” electrode pairs to treat copper pit water from a copper mine, which can synchronously realize copper embedding and decoppering processes. At the same time, by switching the positive and negative poles of the power source and adjusting the solution of the cathode and anode chambers, the electrode regeneration and copper extraction process are carried out simultaneously, which greatly improves the treatment efficiency of copper-containing wastewater and the service life of electrodes and reduces the cost. In Embodiment 4, the removal rate of Cu(II) ions in step (1) reaches 99.55%, and the removal rates of Fe, Ca, Mg and Pb ions are all less than 5%, indicating that this device system has a good selectivity of Cu(II) ions; in the electrode regeneration process of the secondary treatment in step (2), 198.44 mg/L high-concentration copper-containing solution is obtained in the anode chamber, and the desorption rate reaches 99.22%, with a good desorption effect; repeat step (2) for 15 times, that is, performing the 17th treatment; after electrode regeneration for 16 times, the concentration of Cu(II) ions in the copper-containing wastewater in the cathode chamber is reduced from 200 mg/L to 12 mg/L, and the removal rate of Cu(II) ions is 94%, indicating that an efficient extraction of copper ions from the copper-containing wastewater can be realized; at the same time, after electrode regeneration for 16 times, a high-concentration copper-containing solution of 186 mg/L is still obtained in the anode chamber, the desorption rate is up to 93%. The electrode recycling effect is good. The calculation equation of a desorption rate is as follows:

$$D E = \frac{{C}_{t}}{{C}_{0}} \times 100 \%$$

DE: desorption efficiency; Co: initial concentration; Ct: concentration after desorption.

### Embodiment 5

The difference between this embodiment and Embodiment 4 is that the integrated device is used to treat copper-containing wastewater, and there are differences in corresponding operations. The specific operating steps are as follows:
(1) Synchronous realization of copper embedding and decoppering processes: Set up an electrochemical device. Multiple groups of cathodes and anodes are connected in series correspondingly and assembled with multiple anion exchange membranes and a power supply to form an integrated device. The integrated device includes multiple treatment modules, and an electrodialysis reactor is used, with a Cu₂Se electrode as an anode and a CuSe electrode as a cathode; separate the anode and the cathode with an anion exchange membrane; add 100 mL sodium sulfate solution (the concentration of sulfate ion is 0.5 mol/L), a supporting electrolyte solution, into an anode chamber, and add 100 mL copper-containing wastewater (the concentration of Cu(II) ion is 200 mg/L) to be treated into a cathode chamber; after being energized and 1 V DC voltage being applied, Cu(II) ions in the copper-containing wastewater from the cathode chamber are embedded into the cathode material to form a copper-rich Cu₂Se electrode. The reaction is as follows: CuSe+2e⁻+Cu²⁺=Cu₂Se, and at the same time, Cu₂Se as an anode loses Cu(I) ions to become a copper-deficient CuSe electrode. The reaction is as follows: Cu₂Se−2e⁻=CuSe+Cu²⁺; after 60 min of energization, the anode chamber obtains a high-concentration copper-containing solution of 199.36 mg/L. Cu(II) ions in the copper-containing wastewater flowing into the cathode chamber will be selectively adsorbed to the cathode material, and the concentration of copper ions in the treated copper-containing wastewater is 0.89 mg/L.
(2) A first enrichment process: replace the wastewater treated in the cathode chamber with fresh copper-containing wastewater, repeat step (1) for 50 times to enrich Cu(II) ions, and obtain a 10,100 mg/L high-concentration copper-containing solution in the anode chamber after enrichment.
(3) Regeneration process: Switch the positive and negative poles of the power supply to exchange electrodes. With a copper-rich Cu₂Se electrode generated in step (2) as the anode and a copper-deficient CuSe electrode generated in step (2) as the cathode, replace the solution in the anode chamber where the copper-rich Cu₂Se electrode is located with 100 mL of sodium sulfate solution (the concentration of sulfate ion is 0.5 mol/L), a fresh supporting electrolyte salt solution and replace the solution in the cathode chamber where the copper-deficient CuSe electrode is located with 100 mL of copper-containing wastewater (the concentration of Cu(II) ions is 200 mg/L); repeat the process of step (1) by energizing again with an electrification voltage of 1 V and an electrification time of 60 min to perform anode decoppering and cathode copper embedding, so that a high-concentration copper-containing solution can be obtained in the anode chamber, and Cu(II) ions in the copper-containing wastewater flowing into the cathode chamber will be selectively adsorbed to the cathode material so as to extract copper from the copper-containing wastewater and complete the cyclic regeneration of electrodes at the same time.
(4) A second enrichment process: replace the wastewater treated in the cathode chamber with fresh copper-containing wastewater, repeat step (3) for 50 times to enrich Cu(II) ions, and obtain a 10,000 mg/L high-concentration copper-containing solution in the anode chamber after enrichment.
(5) After completing step (2) or step (4), the enriched high-concentration copper-containing solution in the anode chamber is collected and used for electrolytic refining of blister copper after impurity removal to obtain high-purity electrolytic copper with a purity of more than 99%.

In Embodiment 5, multiple treatment units are further integrated, so that copper can be enriched even when the concentration of Cu(II) ions in copper-containing wastewater is low, thus further applying the extracted copper to electrolytic refining of blister copper, and realizing all-round copper treatment in a process of copper-containing wastewater treatment-scrap copper extraction-application. It has high application value and is worthy of industrial promotion.

### Embodiment 6

(1) Synchronous realization of copper embedding and decoppering processes: Set up an electrochemical device and use an electrodialysis reactor, with a Cu₂S electrode as an anode and a CuS electrode as a cathode; separate the anode and the cathode with an anion exchange membrane; add 100 mL potassium sulfate solution (the concentration of sulfate ion is 1.0 mol/L), a supporting electrolyte solution, into an anode chamber, and add 100 mL copper-containing wastewater (the concentration of Cu(II) ion is 1,000 mg/L) to be treated into a cathode chamber; after being energized and 0.1 V DC voltage being applied, Cu(II) ions in the copper-containing wastewater from the cathode chamber are embedded into the cathode material to form a copper-rich Cu₂S electrode. The reaction is as follows: CuS+2e⁻+Cu²⁺=Cu₂S, and at the same time, Cu₂S as an anode loses Cu(I) ions to become a copper-deficient CuS electrode. The reaction is as follows: Cu₂S−2e⁻CuS+Cu²⁺; after 180 min of energization, the anode chamber obtains a high-concentration copper-containing solution of 996 mg/L. Cu(II) ions in the copper-containing wastewater flowing into the cathode chamber will be selectively adsorbed to the cathode material, and the concentration of copper ions in the treated copper-containing wastewater is 9.8 mg/L.

(2) Regeneration process: After the reaction is completed, switch the positive and negative poles of the power supply to exchange electrodes. With a copper-rich Cu₂S electrode generated in step (1) as the anode and a copper-deficient CuS electrode generated in step (1) as the cathode, replace the solution in the anode chamber where the copper-rich Cu₂S electrode is located with 100 mL of potassium sulfate solution (the concentration of sulfate ion is 1.0 mol/L), a fresh supporting electrolyte salt solution and replace the solution in the cathode chamber where the copper-deficient CuS electrode is located with 100 mL of copper-containing wastewater (the concentration of Cu(II) ions is 1,000 mg/L); repeat the process of step (1) by energizing again with an electrification voltage of 0.1 V and an electrification time of 180 min to perform anode decoppering and cathode copper embedding, so that a high-concentration copper-containing solution of 978 mg/L can be obtained in the anode chamber, and Cu(II) ions in the copper-containing wastewater flowing into the cathode chamber will be selectively adsorbed to the cathode material so as to extract copper from the copper-containing wastewater and complete the cyclic regeneration of electrodes at the same time.

In step (1), the Cu₂S electrode is prepared by mixing Cu₂S, carbon nanotubes and binder PVDF at a mass ratio of 8:1:1, and the CuS electrode is prepared by mixing CuS, carbon nanotubes and binder PVDF at a mass ratio of 8:1:1. The specific preparation method is the same as that in Embodiment 1.

The copper-containing wastewater is the integrated copper-containing wastewater of PCB circuit board production process with pH-4, and its chemical composition is as shown in Table 2.

TABLE 2
Chemical Composition of Integrated
Copper-containing Wastewater (in mg/L)

| | | | Total | | | |
|---|---|---|---|---|---|---|
| Composition | Cu | COD | phosphorus | Zn | Pb | SO₄²⁻ |
| Content | 1000 | 200 | 180 | 96 | 1.8 | 15000 |

In Embodiment 6, an electrochemical device is constructed with “CuSe|Cu2Se” electrode pairs to treat the integrated copper-containing wastewater from PCB circuit board production process, which can synchronously realize copper embedding and decoppering processes. At the same time, by switching the positive and negative poles of the power source and adjusting the solution of the cathode and anode chambers, the electrode regeneration and copper extraction process are carried out simultaneously, which greatly improves the treatment efficiency of copper-containing wastewater. In Embodiment 6, the removal rate of Cu(II) ions in step (1) reaches 99.02%, and the desorption rate in the electrode regeneration process of the secondary treatment in step (2) reaches 97.8%. The electrode recycling effect is good. Repeat step (2) for 15 times, that is, performing the 17th treatment; after electrode regeneration for 16 times, the concentration of Cu(II) ions in the copper-containing wastewater in the cathode chamber is reduced from 1,000 mg/L to 30 mg/L, and the removal rate of Cu(II) ions is 97%, indicating that an efficient extraction of copper ions from the copper-containing wastewater can be realized; at the same time, after electrode regeneration for 16 times, a high-concentration copper-containing solution of 950 mg/L is still obtained in the anode chamber, the desorption rate is up to 95%. The electrode recycling effect is good.

### Embodiment 7

(1) Synchronous realization of copper embedding and decoppering processes: Set up an electrochemical device and use an electrodialysis reactor, with a Cu₂S_{0.3}Se_{0.7} electrode as an anode and a CuS_{0.3}Se_{0.7} electrode as a cathode; separate the anode and the cathode with an anion exchange membrane; add 100 mL potassium sulfate solution (the concentration of chloride ions is 2.0 mol/L), a supporting electrolyte solution, into an anode chamber, and add 100 mL copper-containing wastewater (the concentration of Cu(II) ion is 1,000 mg/L) to be treated into a cathode chamber; after being energized and 1.4 V DC voltage being applied, Cu(II) ions in the copper-containing wastewater from the cathode chamber are embedded into the cathode material to form a copper-rich Cu₂S_{0.3}Se_{0.7} electrode. The reaction is as follows: CuS_{0.3}Se_{0.7}+2e⁻+Cu₂+=Cu₂S_{0.3}Se_{0.7}, and at the same time, Cu₂S_{0.3}Se_{0.7} as an anode loses Cu(I) ions to become a copper-deficient CuS_{0.3}Se_{0.7} electrode. The reaction is as follows: Cu₂S_{0.3}Se_{0.7}−2e⁻=CuS_{0.3}Se_{0.7}+Cu²⁺; after 120 min of energization, the anode chamber obtains a high-concentration copper-containing solution of 988 mg/L. Cu(II) ions in the copper-containing wastewater flowing into the cathode chamber will be selectively adsorbed to the cathode material, and the concentration of copper ions in the treated copper-containing wastewater is 6.3 mg/L.

(2) Regeneration process: After the reaction is completed, switch the positive and negative poles of the power supply to exchange electrodes. With a copper-rich electrode generated in step (1) as the anode and a copper-deficient electrode generated in step (1) as the cathode, replace the solution in the anode chamber where the copper-rich electrode is located with 100 mL of potassium sulfate solution (the concentration of chloride ions is 2.0 mol/L), a fresh supporting electrolyte salt solution and replace the solution in the cathode chamber where the copper-deficient electrode is located with 100 mL of copper-containing wastewater (the concentration of Cu(II) ions is 1,000 mg/L); repeat the process of step (1) by energizing again with an electrification voltage of 1.4 V and an electrification time of 120 min to perform anode decoppering and cathode copper embedding, so that a high-concentration copper-containing solution of 966 mg/L can be obtained in the anode chamber, and Cu(II) ions in the copper-containing wastewater flowing into the cathode chamber will be selectively adsorbed to the cathode material so as to extract copper from the copper-containing wastewater and complete the cyclic regeneration of electrodes at the same time

In step (1), the Cu₂S_{0.3}Se_{0.7} electrode is prepared by mixing Cu₂S_{0.3}Se_{0.7}, graphite and binder PVDF at a mass ratio of 9:2:1, and the CuS_{0.3}Se_{0.7} electrode is prepared by mixing CuS_{0.3}Se_{0.7}, graphite and binder PVDF at a mass ratio of 9:2:1. The specific preparation method is the same as that in Embodiment 2.

The source and composition of the copper-containing wastewater are the same as those in Embodiment 6.

In Embodiment 7, an electrochemical device is constructed with “CuS_{0.3}Se_{0.7}|Cu₂S_{0.3}Se_{0.7}” electrode pairs to treat the integrated copper-containing wastewater from PCB circuit board production process, which can synchronously realize copper embedding and decoppering processes. At the same time, by switching the positive and negative poles of the power source and adjusting the solution of the cathode and anode chambers, the electrode regeneration and copper extraction process are carried out simultaneously, which greatly improves the treatment efficiency of copper-containing wastewater. In Embodiment 9, the removal rate of Cu(II) ions in step (1) reaches 99.17%, and the desorption rate in the electrode regeneration process of the secondary treatment in step (2) reaches 96.6%. The electrode recycling effect is good. Repeat step (2) for 15 times, that is, performing the 17th treatment; after electrode regeneration for 16 times, the concentration of Cu(II) ions in the copper-containing wastewater in the cathode chamber is reduced from 1,000 mg/L to 46 mg/L, and the removal rate of Cu(II) ions is 95.4%, indicating that an efficient extraction of copper ions from the copper-containing wastewater can be realized; at the same time, after electrode regeneration for 16 times, a high-concentration copper-containing solution of 948 mg/L is still obtained in the anode chamber, the desorption rate is up to 94.8%. The electrode recycling effect is good.

### Embodiment 8

(1) Synchronous realization of copper embedding and decoppering processes: Set up an electrochemical device. Multiple groups of cathodes and anodes are connected in series correspondingly and assembled with multiple anion exchange membranes and a power supply to form an integrated device. The integrated device includes multiple treatment modules, and an electrodialysis reactor is used, with a Cu₂S@Cu₂Se electrode as an anode and a CuS@CuSe electrode as a cathode; separate the anode and the cathode with an anion exchange membrane; add 100 mL sodium sulfate solution (the concentration of sulfate ion is 2.0 mol/L), a supporting electrolyte solution, into an anode chamber, and add 100 mL copper-containing wastewater (the concentration of Cu(II) ion is 10 mg/L) to be treated into a cathode chamber; after being energized and 1 V DC voltage being applied, Cu(II) ions in the copper-containing wastewater from the cathode chamber are embedded into the cathode material to form a copper-rich Cu₂S@Cu₂Se electrode. The reaction is as follows: CuS@CuSe+4e⁻+2 Cu₂₊=Cu₂S@Cu₂Se, and at the same time, Cu₂S@Cu₂Se as an anode loses Cu(I) ions to become a copper-deficient CuS@CuSe electrode. The reaction is as follows: Cu₂S@Cu₂Se−4e⁻=CuS@CuSe+2Cu²⁺. Keep replacing the wastewater treated in the cathode chamber with fresh copper-containing wastewater to enrich copper (II) ions. After enrichment, the anode chamber obtains a high-concentration copper-containing solution of 10,000 mg/L. Cu(II) ions in the copper-containing wastewater flowing into the cathode chamber will be selectively adsorbed to the cathode material, and the concentration of copper ions in the treated copper-containing wastewater is 0.05 mg/L.

(2) Regeneration process: After the reaction is completed, switch the positive and negative poles of the power supply to exchange electrodes. With a copper-rich Cu₂S@Cu₂Se electrode generated in step (1) as the anode and a copper-deficient CuS@CuSe electrode generated in step (1) as the cathode, replace the solution in the anode chamber where the copper-rich Cu₂S@Cu₂Se electrode is located with 100 mL of potassium sulfate solution (the concentration of chloride ions is 2.0 mol/L), a fresh supporting electrolyte salt solution and replace the solution in the cathode chamber where the copper-deficient CuS@CuSe electrode is located with 100 mL of copper-containing wastewater (the concentration of Cu(II) ions is 10 mg/L); repeat the process of step (1) by energizing again with an electrification voltage of 1 V to perform anode decoppering and cathode copper embedding, Keep replacing the wastewater treated in the cathode chamber with fresh copper-containing wastewater to enrich copper (II) ions. After enrichment, the anode chamber obtains a high-concentration copper-containing solution of 10,000 mg/L. and Cu(II) ions in the copper-containing wastewater flowing into the cathode chamber will be selectively adsorbed to the cathode material so as to extract copper from the copper-containing wastewater and complete the cyclic regeneration of electrodes at the same time.

(3) After completing step (1) or step (2), the enriched high-concentration copper-containing solution in the anode chamber is collected and used for electrolytic refining of blister copper after impurity removal to obtain high-purity electrolytic copper with a purity of more than 99%.

In step (1), the Cus@CuSe electrode is prepared by mixing Cus@CuSe, graphite and binder PVDF at a mass ratio of 9:2:1, and the Cu₂S@Cu₂Se electrode is prepared by mixing Cu₂S@Cu₂Se, graphite and binder PVDF at a mass ratio of 9:2:1. The specific preparation method is the same as that in Embodiment 2.

The pH value of the copper-containing wastewater is 5.

In Embodiment 8, an electrochemical device is constructed with “Cus@CuSe|Cu₂S@Cu₂Se” electrode pairs to treat copper-containing wastewater, which can synchronously realize copper embedding and decoppering processes. At the same time, by switching the positive and negative poles of the power source and adjusting the solution of the cathode and anode chambers, the electrode regeneration and copper extraction process are carried out simultaneously, which greatly improves the treatment efficiency of copper-containing wastewater. In Embodiment 8, the removal rate of Cu(II) ions reaches 99.5%, and the desorption rate in the electrode regeneration process of the secondary treatment and enrichment in step (2) reaches 99.1%. The electrode recycling effect is good. Repeat step (2) for 15 times, that is, performing the 17th treatment; after electrode regeneration for 16 times, the concentration of Cu(II) ions in the copper-containing wastewater in the cathode chamber is reduced from 10 mg/L to 0.24 mg/L, and the removal rate of Cu(II) ions is 97.6%, indicating that an efficient extraction of copper ions from the copper-containing wastewater can be realized; at the same time, after electrode regeneration for 16 times, a high-concentration copper-containing solution of 9.65 mg/L is still obtained in the anode chamber before enrichment, the desorption rate is up to 96.5%. The electrode recycling effect is good.

### Embodiment 9

(1) Synchronous realization of copper embedding and decoppering processes: Set up an electrochemical device. Multiple groups of cathodes and anodes are connected in series correspondingly and assembled with multiple anion exchange membranes and a power supply to form an integrated device. The integrated device includes multiple treatment modules, and an electrodialysis reactor is used, with a Cu₂Te electrode as an anode and a CuTe electrode as a cathode; separate the anode and the cathode with an anion exchange membrane; add 100 mL sodium sulfate solution (the concentration of sulfate ion is 2.0 mol/L), a supporting electrolyte solution, into an anode chamber, and add 100 mL copper-containing wastewater (the concentration of Cu(II) ion is 10 mg/L) to be treated into a cathode chamber; after being energized and 1 V DC voltage being applied, Cu(II) ions in the copper-containing wastewater from the cathode chamber are embedded into the cathode material to form a copper-rich Cu₂Te electrode. The reaction is as follows: CuTe+2e⁻+Cu²⁺=Cu₂Te, and at the same time, Cu₂Te as an anode loses Cu(I) ions to become a copper-deficient CuTe electrode. The reaction is as follows: Cu₂Te−2e⁻=CuTe+Cu²⁺. Keep replacing the wastewater treated in the cathode chamber with fresh copper-containing wastewater to enrich copper (II) ions. After enrichment, the anode chamber obtains a high-concentration copper-containing solution of 10,000 mg/L. Cu(II) ions in the copper-containing wastewater flowing into the cathode chamber will be selectively adsorbed to the cathode material, and the concentration of copper ions in the treated copper-containing wastewater is 0.1 mg/L.

(2) Regeneration process: After the reaction is completed, switch the positive and negative poles of the power supply to exchange electrodes. With a copper-rich Cu₂Te electrode generated in step (1) as the anode and a copper-deficient CuTe electrode generated in step (1) as the cathode, replace the solution in the anode chamber where the copper-rich Cu₂Te electrode is located with 100 mL of sodium chloride solution (the concentration of chloride ions is 2.0 mol/L), a fresh supporting electrolyte salt solution and replace the solution in the cathode chamber where the copper-deficient CuTe electrode is located with 100 mL of copper-containing wastewater (the concentration of Cu(II) ions is 10 mg/L); repeat the process of step (1) by energizing again with an electrification voltage of 1V to perform anode decoppering and cathode copper embedding, Keep replacing the wastewater treated in the cathode chamber with fresh copper-containing wastewater to enrich copper (II) ions. After enrichment, the anode chamber obtains a high-concentration copper-containing solution of 10,000 mg/L. and Cu(II) ions in the copper-containing wastewater flowing into the cathode chamber will be selectively adsorbed to the cathode material so as to extract copper from the copper-containing wastewater and complete the cyclic regeneration of electrodes at the same time.

(3) After completing step (1) or step (2), the enriched high-concentration copper-containing solution in the anode chamber is collected and used for electrolytic refining of blister copper after impurity removal to obtain high-purity electrolytic copper with a purity of more than 99%.

In step (1), the CuTe electrode is prepared by mixing CuTe, graphite and binder PVDF at a mass ratio of 9:2:1, and the Cu₂Te electrode is prepared by mixing Cu₂Te, graphite and binder PVDF at a mass ratio of 9:2:1. The specific preparation method is the same as that in Embodiment 2.

The pH value of the copper-containing wastewater is 5.

In Embodiment 9, an electrochemical device is constructed with “CuTe|Cu₂Te” electrode pairs to treat copper-containing wastewater, which can synchronously realize copper embedding and decoppering processes. At the same time, by switching the positive and negative poles of the power source and adjusting the solution of the cathode and anode chambers, the electrode regeneration and copper extraction process are carried out simultaneously, which greatly improves the treatment efficiency of copper-containing wastewater. In Embodiment 9, the removal rate of Cu(II) ions reaches 99%, and the desorption rate in the electrode regeneration process of the secondary treatment and enrichment in step (2) reaches 96.2%. The electrode recycling effect is good. Repeat step (2) for 15 times, that is, performing the 17th treatment; after electrode regeneration for 16 times, the concentration of Cu(II) ions in the copper-containing wastewater in the cathode chamber is reduced from 10 mg/L to 0.62 mg/L, and the removal rate of Cu(II) ions is 93.8%, indicating that an efficient extraction of copper ions from the copper-containing wastewater can be realized; at the same time, after electrode regeneration for 16 times, a high-concentration copper-containing solution of 9.26 mg/L is still obtained in the anode chamber before enrichment, the desorption rate is up to 92.6%. The electrode recycling effect is good.

In Embodiments 4-9, an electrodialysis reaction device is assembled with counter electrodes composed of Cu-based chalcogenide, an anion exchange membrane and a power supply respectively. The active materials of the cathode and anode of the reaction device are all Cu-based chalcogenide, so that the anode decoppering and cathode copper embedding can be carried out synchronously to improve the treatment speed; in addition, the electrode regeneration and copper extraction process are synchronized by switching the positive and negative poles of the power supply and adjusting the solution in the cathode and anode chambers, so as to realize continuous treatment of copper-containing wastewater and greatly improve the efficiency of copper extraction; furthermore, the service life of electrode is greatly prolonged and the cost is reduced through electrode regeneration operation. The electrodialysis reaction device and method of Embodiments 4-9 can be used to treat actual wastewater, with a high removal rate and selectivity of Cu(II) ions in wastewater and a good application effect. In addition, by setting up the integrated device, Cu(II) ions can be enriched during the treatment of copper-containing wastewater so that its concentration reaches 10,000 mg/L, which is then applied to refining of blister copper to obtain high-purity electrolytic copper.

### Embodiment 10

Set up an electrochemical device and use the carbon-selenium composite material as the cathode material. Specifically, selenium powder and activated carbon are mixed to prepare an electrode as the cathode electrode. One of the above electrodes can be selected as the anode electrode. When copper-containing wastewater contacts the electrode, selenium ions will combine with copper ions to form a copper-based electrode. With four-electron reactions under continuous switching, the carbon-selenium composite electrode can obtain a higher adsorption capacity and a higher adsorption rate of copper ions. The reaction is as follows: Se↔CuSe↔Cu₃Se₂↔Cu₂−xSe↔Cu₂Se. The adsorption capacity reaches 626.71 mg/g and the initial adsorption rate was 13.59 mg·g·min⁻¹ in 500 ppm copper-containing wastewater. By changing the positive and negative poles of the power supply and enriching Cu²⁺ in a certain concentration of electrolyte solution, the desorption rate of Cu-based electrode reached 98.2% during regeneration before secondary treatment and enrichment. The electrode recycling effect is good.

To sum up, the present disclosure uses Cu-based chalcogenide as an electrode material and forms an electrochemical device with other electrodes. The device is an electrocatalytic coupling deionization system with electrochemical oxidative decomplexing performance, and has a good effect of selectively removing Cu(II) ions from organic complex copper-containing wastewater, strongly acidic wastewater, and wastewater interfered by high-concentration salt ions and heavy metal ions. In the present disclosure, Cu-based chalcogenide is further simultaneously used as cathode and anode active materials to form counter electrodes. The counter electrodes are assembled with an anion exchange membrane and a power source to form an electrodialysis reaction device, so that decoppering and copper embedding reactions can be carried out at the same time within a lower voltage and a wider pH range. The regeneration step combined with electrodes enables a continuous copper extraction operation, greatly improves copper extraction efficiency, and has high removal efficiency and good selectivity of Cu(II) ions from copper-containing wastewater.

The present disclosure has been further described above with reference to specific embodiments, but it should be understood that the specific description herein shall not be construed as limiting the essence and scope of the present disclosure. All modifications made by ordinary persons skilled in the art to the above embodiments after reading this specification fall within the protection scope of the present disclosure.

What is claimed is:

1. An electrochemical device for extracting copper from copper-containing wastewater, wherein an anode material of the electrochemical device is one of activated carbon, graphite, lead dioxide, BDD and CuₘX_{1-a-b}YₐZ_{b}; a cathode material is one of CuₙX_{1-c-d}Y_{c}Z_{d} and carbon-selenium composite materials, and a cathode and an anode are respectively connected with a power supply to treat the copper-containing wastewater;
wherein 1<m≤2, 1≤n<2 and m>n; 0≤a≤1, 0≤b≤1 and 0≤a+b≤1; 0≤c≤1, 0≤d≤1 and 0≤c+d≤1; X, Y and Z are selected from a group consisting of S, Se and Te.

2. The electrochemical device for extracting copper from copper-containing wastewater according to claim 1, wherein the anode material of the electrochemical device is one of activated carbon, graphite, lead dioxide and BDD materials; the cathode material is one of copper selenide, copper selenide sulfide and carbon-selenium composite materials; the anode and the cathode are connected to the power supply and applied with a direct current of 0.6-4.0V, and the device is used for treating acidic electroplating wastewater containing Cu-EDTA.

3. The electrochemical device for extracting copper from copper-containing wastewater according to claim 2, wherein the preparation steps of the copper selenide material are as follows:
stirring and dissolving selenium powder in hydrazine hydrate to obtain a mixture A; mixing ethanol with water, adding anhydrous copper chloride for stirring and dissolving to obtain a mixture B; mixing A and B to obtain a mixture C, putting the mixture C into an oven, heating it to 150-200° C. to react for 20 h-30 h to obtain a crude product of copper selenide.

4. The electrochemical device for extracting copper from copper-containing wastewater according to claim 3, wherein the molar ratio of the selenium powder to the anhydrous copper chloride is 1:1.

5. The electrochemical device for extracting copper from copper-containing wastewater according to claim 2, wherein when the cathode material is copper selenide, the cathode electrode is obtained by the following method:
mixing conductive carbon black and copper selenide material evenly, adding them into a solvent for stirring, adding a binder and continuing to stir until an uniform mixture is obtained; coating the obtained mixture on a graphite paper, drying the coated graphite paper at 60° C. for 24 h, and finally obtaining a cathode electrode with copper selenide as an active material.

6. The electrochemical device for extracting copper from copper-containing wastewater according to claim 2, wherein when the anode material is activated carbon, the anode electrode is obtained by the following method: mixing a conductive carbon black and the activated carbon material evenly, then adding them into a solvent for stirring, adding an adhesive and continuing to stir until a mixture is obtained uniformly; coating the obtained mixture on a graphite paper, and drying the coated graphite paper at 60° C. for 24 h to finally obtain an anode electrode.

7. The electrochemical device for extracting copper from copper-containing wastewater according to claim 1, wherein the electrochemical device further comprises an anion exchange membrane.

8. A method for extracting copper from copper-containing wastewater, wherein the copper in the copper-containing wastewater is extracted by an electrochemical process using the electrochemical device according to claim 1.

9. The method for extracting copper from copper-containing wastewater according to claim 8, wherein the method comprises the following steps of:
(1) synchronous realization of copper embedding and decoppering processes: use an electrodialysis reactor, with a CuₘX_{1-a-b}YₐZ_{b} electrode as an anode and a CuₙX_{1-c-d}Y_{c}Z_{d} electrode as a cathode; separate the anode and the cathode with an anion exchange membrane; add a supporting electrolyte salt solution into an anode chamber, and add copper-containing wastewater to be treated into a cathode chamber; after being energized, a copper-rich electrode is formed at the cathode and a copper-deficient electrode is formed at the anode; a high-concentration copper-containing solution is obtained in the anode chamber, and Cu(II) ions in the copper-containing wastewater in the cathode chamber is selectively adsorbed to the cathode material; and
(2) regeneration process: after the reaction in step (1) is completed, switch the positive and negative poles of the power supply to exchange electrodes; replace the solution in the anode chamber after electrode exchange with a fresh supporting electrolyte salt solution, and replace the solution in the cathode chamber after electrode exchange with copper-containing wastewater; electrify the anode again for decoppering and the cathode for copper embedding, so as to extract copper from the copper-containing wastewater and complete the cyclic regeneration of electrodes;
wherein 1<m≤2, 1≤n<2 and m>n; 0≤a≤1, 0≤b≤1 and 0≤a+b≤1; 0≤c≤1, 0≤d≤1 and 0≤c+d≤1; X, Y and Z are selected from a group consisting of S, Se and Te.

10. The method for extracting copper from copper-containing wastewater according to claim 9, wherein the method comprises the following steps of:
(1) synchronous realization of copper embedding and decoppering processes: use an electrodialysis reactor, with a Cu₂Se electrode as an anode and a CuSe electrode as a cathode; separate the anode and the cathode with an anion exchange membrane; add a supporting electrolyte salt solution into an anode chamber, and add copper-containing wastewater to be treated into a cathode chamber; after being energized, Cu(II) ions in the copper-containing wastewater of the cathode chamber embed into the cathode material to form a copper-rich Cu₂Se electrode, and at the same time, Cu₂Se as an anode active material loses copper (I) ions to become a copper-deficient CuSe electrode; a high-concentration copper-containing solution is obtained in the anode chamber, and Cu(II) ions in the copper-containing wastewater flowing into the cathode chamber will be selectively adsorbed to the cathode material; and
(2) regeneration process: after the reaction in step (1) is completed, switch the positive and negative poles of the power supply to exchange electrodes; with a copper-rich Cu₂Se electrode generated in step (1) as the anode and a copper-deficient CuSe electrode generated in step (1) as the cathode, replace the solution in the anode chamber where the copper-rich Cu₂Se electrode is located with a fresh supporting electrolyte salt solution, and replace the solution in the cathode chamber where the copper-deficient CuSe electrode is located with copper-containing wastewater; electrify the anode again for decoppering and the cathode for copper embedding, so as to extract copper from the copper-containing wastewater and complete the cyclic regeneration of electrodes.

11. The method for extracting copper from copper-containing wastewater according to claim 9, wherein after the step (1) or the step (2) is completed, collect the high-concentration copper-containing solution in the anode chamber and use it after impurity removal for electrolytic refining of blister copper.

12. The method for extracting copper from copper-containing wastewater according to claim 11, wherein the concentration of Cu(II) ions in the high-concentration copper-containing solution is above 10,000 mg/L, and the method for impurity removal is electrolysis.

13. The method for extracting copper from copper-containing wastewater according to claim 9, wherein in the step (1) and the step (2), the voltage of energization is 0.1V-1.4V, and the duration of energization is 60 min-180 min.

14. The method for extracting copper from copper-containing wastewater according to claim 10, wherein in the step (1), the Cu₂Se electrode is prepared by mixing Cu₂Se, conductive carbon material and binder PVDF at a mass ratio of 7-9:2-0.5:1-0.5.

15. The method for extracting copper from copper-containing wastewater according to claim 10, wherein in the step (1), the CuSe electrode is prepared by mixing CuSe, conductive carbon material and binder PVDF at a mass ratio of 7-9:2-0.5:1-0.5.

16. The method for extracting copper from copper-containing wastewater according to claim 14, wherein the conductive carbon material is one or more selected from a group consisting of acetylene black, carbon nanotubes, graphene, graphite and carbon fiber.

17. The method for extracting copper from copper-containing wastewater according to claim 9, wherein in step (1) and step (2), the supporting electrolyte salt solution is a sulfate solution or a chloride solution, a concentration of sulfate ions in the sulfate solution is 0.1 mol/L-2 mol/L, and a concentration of chloride ions in the chloride solution is 0.1 mol/L-2 mol/L.

18. The method for extracting copper from copper-containing wastewater according to claim 9, wherein the step (2) is repeated 10 times to 20 times.

19. The method for extracting copper from copper-containing wastewater according to claim 10, wherein the copper-containing wastewater is one of acidic electroplating wastewater, integrated discharged wastewater generated in circuit board printing, copper-containing wastewater from copper ore smelting and copper-containing wastewater after decomplexing.

20. The method for extracting copper from copper-containing wastewater according to claim 19, wherein the concentration of Cu(II) ions in the copper-containing wastewater is 0.5 mg/L-10,000 mg/L; and the pH value of the copper-containing wastewater is 0.1-5.0.
